(19) United States
(12) Patent Application Publication
(10) Pub. No.: US 2024/0257121 A1
(43) Pub. Date: Aug. 1, 2024

(54) METHOD FOR ISSUING FAN TOKEN BASED ON BLOCKCHAIN NETWORK AND BLOCKCHAIN SYSTEM USING THE SAME

(71) Applicant: Wemade Co., Ltd., Seongnam-si (KR)

(72) Inventor: Moheon SONG, Seoul (KR)

(21) Appl. No.: 18/406,519

(22) Filed: Jan. 8, 2024

(30) Foreign Application Priority Data
Jan. 26, 2023 (KR) 1020230010466
Mar. 7, 2023 (KR) 1020230030185

(51) Int. Cl. G06Q 20/38; G06Q 20/36; G06Q 20/40

(52) U.S. Cl. CPC G06Q 20/389; G06Q 20/3672; G06Q 20/401

(57) ABSTRACT

A method for issuing fan tokens based on a blockchain network is provided. The method includes steps of: allowing a minter to mint fan tokens as much as a preset total upper limit of issuing the fan tokens, allowing the minter to issue the fan tokens to a vault as much as an initial issued number, and allowing a creator to distribute the fan tokens deposited in the vault, thereby registering information on the initial issued number of the fan tokens and thus updating information on a current total issued amount of the fan tokens; and acquiring price information of the fan tokens exchanged in a liquidity pool, allowing the minter to additionally issue the fan tokens to the vault as much as a specific multiple of a preset unit number corresponding to a first price fluctuation condition, and registering information on the specific multiple of the preset unit number.

### CROSS REFERENCE OF RELATED APPLICATION

This present application claims the benefit of the earlier filing date of Korean provisional patent application No. 10-2023-0010466, filed on Jan. 26, 2023, and the earlier filing date of Korean non-provisional patent application No. 10-2023-0030185, filed on Mar. 7, 2023, the entire contents of which being incorporated herein by reference.

### FIELD OF THE DISCLOSURE

The present disclosure relates to a method for issuing fan tokens based on a blockchain network and a blockchain system using the same; and more particularly, to the method for issuing the fan tokens based on the blockchain network capable of controlling an amount of distribution of the fan tokens by additionally issuing as much as a specific multiple of a preset unit number corresponding to a price fluctuation condition and the blockchain system using the same.

### BACKGROUND OF THE DISCLOSURE

Various cryptocurrencies are being developed based on a blockchain technology. For example, “coin” such as a cryptocurrency constituting an independent ecosystem with its own main net or an independent cryptocurrency which is not dependent on another platform is used in payments or services.

In addition, NFTs, i.e., Non-Fungible Tokens, related to artworks are issued.

Recently, star performers, Youtubers, writers, sports stars or sports teams are issuing and distributing fan tokens based on their fandom.

From the fan tokens, a creator may expect a higher remuneration (profit) for his or her own activities, activate a fan community, and build a transparent and fair creator economy model, while fans may participate in community economic ecosystems as a consumer position, get remuneration for the participation, and expect potential investment profit according to the increase in the value of the fan tokens.

According to such conventional fan tokens, since a total amount of the fan tokens to be issued is not accurately determined, the fan tokens may be additionally issued in response to a demand for the fan tokens. Thus, an accurate amount of distribution of the fan tokens cannot be known, and a reliability for the fan tokens is not guaranteed.

In addition, according to such conventional fan tokens, there may be a problem of inflation in the fan tokens since a quantity of the fan tokens naturally increases as time goes by according to a growth of the fan tokens.

### SUMMARY OF THE DISCLOSURE

It is an object of the present disclosure to solve all the aforementioned problems.

It is another object of the present disclosure to guarantee a reliability for fan tokens by accurately informing an amount of distribution of the fan tokens.

It is still another object of the present disclosure to prevent inflation of the fan tokens by controlling an issued amount of the fan tokens in response to a price fluctuation.

It is still yet another object of the present disclosure to allow a creator to control the distribution of the fan tokens issued.

In accordance with one aspect of the present disclosure, there is provided a method for issuing one or more fan tokens based on a blockchain network, including steps of: (a) a blockchain system allowing a minter to mint fan tokens as much as a preset total upper limit of issuing the fan tokens, allowing the minter to issue the fan tokens to a vault as much as an initial issued number among the fan tokens of the preset total upper limit, and allowing a creator to distribute the fan tokens deposited in the vault, thereby registering information on the initial issued number of the fan tokens and thus updating information on a current total issued amount of the fan tokens; and (b) the blockchain system acquiring price information of the fan tokens exchanged in a liquidity pool, allowing the minter to additionally issue the fan tokens to the vault as much as a specific multiple of a preset unit number corresponding to a first price fluctuation condition whenever a reference price calculated by referring to the price information of the fan tokens during a preset criterion time is detected to satisfy the first price fluctuation condition, and registering information on the specific multiple of the preset unit number of the fan tokens additionally issued, thereby updating the information on the current total issued amount of the fan tokens.

As one example, at the step of (b), the blockchain system may calculate a time-weighted average price by referring to the price information of the fan tokens as the reference price during the preset criterion time, and checks whether the time-weighted average price exceeds a high-watermark which is a last highest price and whether the time-weighted average price has increased as much as a multiple of a preset unit price or has increased more than the certain multiple of the preset unit price from a specific criterion price among a plurality of preset criterion prices, to thereby check whether the reference price satisfies the first price fluctuation condition.

As one example, at the step of (b), the blockchain system may calculate the time-weighted average price during the preset criterion time for each period of time by referring to the price information of the fan tokens, and in case it is detected that the time-weighted average price exceeds the high-watermark and that the time-weighted average price has increased as much as the multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the time-weighted average price.

As one example, at the step of (b), the blockchain system may acquire the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool.

As one example, at the step of (b), the blockchain system may calculate time-weighted average prices during the criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the specific time-weighted average price.

As one example, at the step of (b), the blockchain system may be prevented from calculating the time-weighted average price during the preset criterion time of an initial stage.

In accordance with another aspect of the present disclosure, there is provided the method for issuing one or more fan tokens based on a blockchain network, including steps of: (a) on condition that a total upper limit of issuing fan tokens has been set, a blockchain system allowing a minter to mint the fan tokens as much as a preset initial minted number, allowing the minter to issue the fan tokens to a vault as much as the preset initial minted number, and allowing a creator to distribute the fan tokens deposited in the vault, thereby registering information on the initial minted number of the fan tokens and thus updating information on a current total issued amount of the fan tokens; and (b) the blockchain system acquiring price information of the fan tokens exchanged in a liquidity pool, calculating a reference price by referring to the price information of the fan tokens during a preset criterion time, allowing the minter to additionally mint the fan tokens as much as a specific multiple of a preset unit number corresponding to a second price fluctuation condition and then to issue the minted fan tokens to the vault whenever the reference price is detected to satisfy the second price fluctuation condition, and registering information on the specific multiple of the preset unit number of the fan tokens additionally minted, thereby updating the information on the current total issued amount of the fan tokens.

As one example, at the step of (b), the blockchain system calculates a time-weighted average price by referring to the price information of the fan tokens as the reference price during the preset criterion time, and checks whether the time-weighted average price exceeds a high-watermark which is a last highest price and whether the time-weighted average price has increased as much as a certain multiple of a preset unit price or has increased more than the certain multiple of the preset unit price from a specific criterion price among a plurality of preset criterion prices, to thereby check whether the reference price satisfies the second price fluctuation condition.

As one example, at the step of (b), the blockchain system may calculate the time-weighted average price during the preset criterion time for each period of time by referring to the price information of the fan tokens, and in case it is detected that the time-weighted average price exceeds the high-watermark and that the time-weighted average price has increased as much as the multiple of the preset unit price or has increased more than the multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the time-weighted average price.

As one example, at the step of (b), the blockchain system may calculate time-weighted average prices during the preset criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the specific time-weighted average price.

As one example, at the step of (b), the blockchain system may allow the creator to transmit the fan tokens to the minter as much as a particular unit number corresponding to a third price fluctuation condition whenever the reference price is detected to satisfy the third price fluctuation condition, and allows the minter to burn the particular multiple of the preset unit number of the fan tokens transmitted from the creator, and registers information on the predetermined unit number of the fan tokens burnt, thereby updating information on the current total issued amount of the fan tokens.

As one example, at the step of (b), the blockchain system may calculate a time-weighted average price by referring to the price information of the fan tokens as the reference price during the preset criterion time, and checks whether the time-weighted average price is maintained for at least a preset time after the time-weighted average price has decreased as much as a multiple of a preset unit price or has decreased more than the multiple of the preset unit price from a specific criterion price, to thereby check whether the reference price satisfies the third price fluctuation condition.

As one example, at the step of (b), the blockchain system may calculate the time-weighted average price during the preset criterion time for each period of time included in each of grouping cycle for additional issuance by referring to the price information of the fan tokens, and (i) in case the time-weighted average price (i-1) exceeds the high-watermark and (i-2) has increased as much as the multiple of the preset unit price or has increased more than the certain multiple of the preset unit price from the specific criterion price corresponding to the information on the current total issued amount, the blockchain system allows the minter to additionally mint the fan tokens as much as a first specific multiple of the preset unit number which is set as corresponding to an increased cardinal number of the preset unit price of the time-weighted average price and then to issue the minted fan tokens to the vault, and (ii) in case the time-weighted average price is maintained for at least a preset time after the time-weighted average price has decreased as much as the multiple of the preset unit price or has decreased more than the multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average price, and allows the minter to burn the unit number of the fan tokens transmitted from the creator.

As one example, at the step of (b), the blockchain system may acquire the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool.

As one example, at the step of (b), the blockchain system may calculate time-weighted average prices during the preset criterion time for each period of time included in each of grouping cycle for additional issuance by referring to the price information of the fan tokens, and in case (i) it is detected that there is a specific time-weighted average price which exceeds the high-watermark and which has increased as much as the multiple of the preset unit price or has increased more than the certain multiple of the preset unit price from the specific criterion price corresponding to the information on the current total issued amount, the blockchain system allows the minter to further mint the fan tokens as much as a first specific multiple of a preset unit number which is set as corresponding to an increased cardinal number of the preset unit price of the specific time-weighted average price, and then to issue the minted fan tokens to the vault, and (ii) in case the time-weighted average prices are maintained for at least a preset time after the time-weighted average prices have decreased as much as the certain multiple of the preset unit price or have decreased more than the certain multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average prices, and allows the minter to burn the unit number of the fan tokens transmitted from the creator.

As one example, at the step of (b), the blockchain system may be prevented from calculating the time-weighted average price during the preset criterion time of an initial stage.

In accordance with still another aspect of the present disclosure, there is provided a blockchain system for issuing one or more fan tokens based on a blockchain network, comprising at least one blockchain node, including: at least one memory that stores instructions; and at least one processor configured to execute the instructions to perform or support another device to perform: (I) a process of a processor allowing a minter to mint fan tokens as much as a preset total upper limit of issuing the fan tokens, allowing the minter to issue the fan tokens to a vault as much as an initial issued number among the fan tokens of the preset total upper limit, and allowing a creator to distribute the fan tokens deposited in the vault, thereby registering information on the initial issued number of the fan tokens and thus updating information on a current total issued amount of the fan tokens; and (II) the processor acquiring price information of the fan tokens exchanged in a liquidity pool, allowing the minter to additionally issue the fan tokens to the vault as much as a specific multiple of a preset unit number corresponding to a first price fluctuation condition whenever a reference price calculated by referring to the price information of the fan tokens during a preset criterion time is detected to satisfy the first price fluctuation condition, and registering information on the specific multiple of the preset unit number of the fan tokens additionally issued, thereby updating the information on the current total issued amount of the fan tokens.

As one example, at the process of (II), the processor may calculate a time-weighted average price by referring to the price information of the fan tokens as the reference price during the preset criterion time, and checks whether the time-weighted average price exceeds a high-watermark which is a last highest price and whether the time-weighted average price has increased as much as a multiple of a preset unit price or has increased more than the certain multiple of the preset unit price from a specific criterion price among a plurality of preset criterion prices, to thereby check whether the reference price satisfies the first price fluctuation condition.

As one example, at the process of (II), the processor may calculate the time-weighted average price during the preset criterion time for each period of time by referring to the price information of the fan tokens, and in case it is detected that the time-weighted average price exceeds the high-watermark and that the time-weighted average price has increased as much as the multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the time-weighted average price.

As one example, at the process of (II), the processor may acquire the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool.

As one example, at the process of (II), the processor calculates time-weighted average prices during the criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the specific time-weighted average price.

As one example, at the process of (II), the processor may be prevented from calculating the time-weighted average price during the preset criterion time of an initial stage.

In accordance with still yet another aspect of the present disclosure, there is provided a blockchain system for issuing one or more fan tokens based on a blockchain network, comprising at least one blockchain node including: at least one memory that stores instructions; and at least one processor configured to execute the instructions to perform or support another device to perform: (I) on condition that a total upper limit of issuing fan tokens has been set, a blockchain system allowing a minter to mint the fan tokens as much as a preset initial minted number, allowing the minter to issue the fan tokens to a vault as much as the preset initial minted number, and allowing a creator to distribute the fan tokens deposited in the vault, thereby registering information on the initial minted number of the fan tokens and thus updating information on a current total issued amount of the fan tokens; and (b) the blockchain system acquiring price information of the fan tokens exchanged in a liquidity pool, calculating a reference price by referring to the price information of the fan tokens during a preset criterion time, allowing the minter to additionally mint the fan tokens as much as a specific multiple of a preset unit number corresponding to a second price fluctuation condition and then to issue the minted fan tokens to the vault whenever the reference price is detected to satisfy the second price fluctuation condition, and registering information on the specific multiple of the preset unit number of the fan tokens additionally minted, thereby updating the information on the current total issued amount of the fan tokens.

As one example, at the process of (II), the processor may calculate a time-weighted average price by referring to the price information of the fan tokens as the reference price during the preset criterion time, and checks whether the time-weighted average price exceeds a high-watermark which is a last highest price and whether the time-weighted average price has increased as much as a certain multiple of a preset unit price or has increased more than the certain multiple of the preset unit price from a specific criterion price among a plurality of preset criterion prices, to thereby check whether the reference price satisfies the second price fluctuation condition.

As one example, at the process of (II), the processor may calculate the time-weighted average price during the preset criterion time for each period of time by referring to the price information of the fan tokens, and in case it is detected that the time-weighted average price exceeds the high-watermark and that the time-weighted average price has increased as much as the multiple of the preset unit price or has increased more than the multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the time-weighted average price.

As one example, at the process of (II), the processor calculates time-weighted average prices during the preset criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the specific time-weighted average price.

As one example, at the process of (II), the processor may allow the creator to transmit the fan tokens to the minter as much as a particular unit number corresponding to a third price fluctuation condition whenever the reference price is detected to satisfy the third price fluctuation condition, and allows the minter to burn the particular multiple of the preset unit number of the fan tokens transmitted from the creator, and registers information on the predetermined unit number of the fan tokens burnt, thereby updating information on the current total issued amount of the fan tokens.

As one example, at the process of (II), the processor may calculate a time-weighted average price by referring to the price information of the fan tokens as the reference price during the preset criterion time, and checks whether the time-weighted average price is maintained for at least a preset time after the time-weighted average price has decreased as much as a multiple of a preset unit price or has decreased more than the multiple of the preset unit price from a specific criterion price, to thereby check whether the reference price satisfies the third price fluctuation condition.

As one example, at the process of (II), the processor may calculate the time-weighted average price during the preset criterion time for each period of time included in each of grouping cycle for additional issuance by referring to the price information of the fan tokens, and (i) in case the time-weighted average price (i-1) exceeds the high-watermark and (i-2) has increased as much as the multiple of the preset unit price or has increased more than the certain multiple of the preset unit price from the specific criterion price corresponding to the information on the current total issued amount, the blockchain system allows the minter to additionally mint the fan tokens as much as a first specific multiple of the preset unit number which is set as corresponding to an increased cardinal number of the preset unit price of the time-weighted average price and then to issue the minted fan tokens to the vault, and (ii) in case the time-weighted average price is maintained for at least a preset time after the time-weighted average price has decreased as much as the multiple of the preset unit price or has decreased more than the multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average price, and allows the minter to burn the unit number of the fan tokens transmitted from the creator.

As one example, at the process of (II), the processor may calculate the time-weighted average price during the preset criterion time for each period of time included in each of grouping cycle for additional issuance by referring to the price information of the fan tokens, and (i) in case the time-weighted average price (i-1) exceeds the high-watermark and (i-2) has increased as much as the multiple of the preset unit price or has increased more than the certain multiple of the preset unit price from the specific criterion price corresponding to the information on the current total issued amount, the blockchain system allows the minter to additionally mint the fan tokens as much as a first specific multiple of the preset unit number which is set as corresponding to an increased cardinal number of the preset unit price of the time-weighted average price and then to issue the minted fan tokens to the vault, and (ii) in case the time-weighted average price is maintained for at least a preset time after the time-weighted average price has decreased as much as the multiple of the preset unit price or has decreased more than the multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average price, and allows the minter to burn the unit number of the fan tokens transmitted from the creator.

As one example, at the process of (II), the processor may acquire the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool.

As one example, at the process of (II), the processor may calculate time-weighted average prices during the preset criterion time for each period of time included in each of grouping cycle for additional issuance by referring to the price information of the fan tokens, and in case (i) it is detected that there is a specific time-weighted average price which exceeds the high-watermark and which has increased as much as the multiple of the preset unit price or has increased more than the certain multiple of the preset unit price from the specific criterion price corresponding to the information on the current total issued amount, the blockchain system allows the minter to further mint the fan tokens as much as a first specific multiple of a preset unit number which is set as corresponding to an increased cardinal number of the preset unit price of the specific time-weighted average price, and then to issue the minted fan tokens to the vault, and (ii) in case the time-weighted average prices are maintained for at least a preset time after the time-weighted average prices have decreased as much as the certain multiple of the preset unit price or have decreased more than the certain multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average prices, and allows the minter to burn the unit number of the fan tokens transmitted from the creator.

As one example, at the process of (II), processor may be prevented from calculating the time-weighted average price during the preset criterion time of an initial stage.

In addition, recordable media that are readable by a computer for storing a computer program to execute the method of the present disclosure is further provided.

In addition, recordable media that are readable by a computer for storing a computer program to execute the method of the present disclosure is further provided.

### BRIEF DESCRIPTION OF THE DRAWINGS

FIG. 1 is a drawing schematically illustrating a blockchain system for issuing one or more fan tokens based on a blockchain network in accordance with one example embodiment of the present disclosure.

FIG. 2 is a drawing schematically illustrating a method for issuing the fan tokens based on the blockchain network in accordance with one example embodiment of the present disclosure.

FIG. 3 is a drawing schematically illustrating a state of issuing the fan tokens depending on time-weighted average price in the method for issuing the fan tokens based on the blockchain network in accordance with one example embodiment of the present disclosure.

### DETAILED DESCRIPTION OF THE PREFERRED EMBODIMENTS

The following detailed description of the present disclosure refers to the accompanying drawings, which show by way of illustration a specific embodiment in which the present disclosure may be practiced, in order to clarify the objects, technical solutions and advantages of the present disclosure. These embodiments are described in sufficient detail to enable those skilled in the art to practice the present disclosure. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to carry out the present disclosure easily, the example embodiments of the present disclosure will be explained by referring to attached diagrams in detail as shown below.

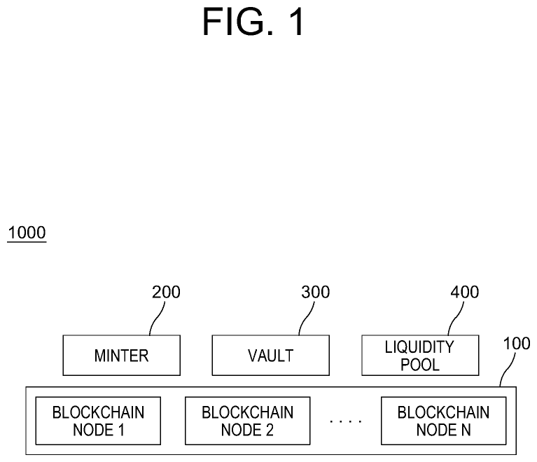

FIG. 1 is a drawing schematically illustrating a blockchain system for issuing one or more fan tokens based on a blockchain network in accordance with one example embodiment of the present disclosure. By referring to FIG. 1, a blockchain system 1000 in accordance with one example embodiment of the present disclosure may include a blockchain network 100, a minter 200, a vault 300 and a liquidity pool 400.

Firstly, the blockchain network 100 may generate blocks through a distributed consensus in a P2P (peer-to-peer) manner by a plurality of blockchain nodes, and link the blocks with a chain to record them in a distributed ledger.

Herein, the blockchain nodes in the blockchain network may include a memory for storing instructions to issue one or more fan tokens based on the blockchain network; and a processor for performing operation for issuing the fan tokens based on the blockchain network according to the instructions in the memory.

Specifically, the blockchain nodes may achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

The communication part of such devices may transmit requests to and receive responses from other linked devices. As one example, such requests and responses may be carried out by the same TCP (transmission control protocol) session, but the scope of the present disclosure is not limited thereto. For example, they could be transmitted and received as UDP (user datagram protocol) datagrams.

Also, the processors of such devices may include hardware configuration of MPU (Micro Processing Unit) or CPU (Central Processing Unit), cache memory, data bus, etc. Additionally, any OS (operating system) and software configuration of applications that achieve specific purposes may be further included.

Next, the minter 200 performs a preset operation over the blockchain network 100, and may additionally issue the fan tokens as much as a preset number or additionally mint the fan tokens as much as a preset number and thus issue the fan tokens whenever a price ratio of the fan tokens to cryptocurrency tokens at the time of exchange between the fan tokens and the cryptocurrency tokens satisfy a preset price fluctuation condition, while preventing the fan tokens from being burnt. However, according to another example, the minter 200 may burn the fan tokens as much as a preset number whenever the price ratio of the fan tokens to the cryptocurrency tokens at the time of the exchange between the fan tokens and the cryptocurrency tokens satisfy the preset price fluctuation condition. In addition, the minter 200 may update information on a current total issued amount of the fan tokens by registering information on amounts of the fan tokens related to issuance, minting and burning thereof.

Herein, the minter 200 may be implemented as at least one of the blockchain nodes which performs operations of issuing, minting and/or burning the fan tokens on the blockchain network 100 or may implemented as a smart contract which performs operations of issuing, minting and/or burning the fan tokens in a virtual machine on the blockchain network 100.

Next, the vault 300 may perform a preset operation over the blockchain network 100, deposit the fan tokens issued by the minter 200, and allow the fan tokens deposited only in at least one electronic wallet registered as a whitelist to be withdrawn.

In addition, the vault 300 may register the information on the withdrawal of the fan tokens in the blockchain network 100.

Herein, the vault 300 may be implemented as at least one of the blockchain nodes which performs an operation of depositing the fan tokens over the blockchain network 100 or may be implemented as a smart contract which performs an operation of depositing the fan tokens in a virtual machine on the blockchain network 100.

Next, the liquidity pool 400 may be an independent blockchain platform in which the blockchain network 100 is implemented, that is, a decentralized exchange (DEX) located in a main net, and as one example, may allow entities to exchange the fan tokens and the cryptocurrency tokens through an atomic swap. In addition, the liquidity pool 400 may allow the entities to supply the fan tokens, thereby securing a liquidity of the fan tokens.

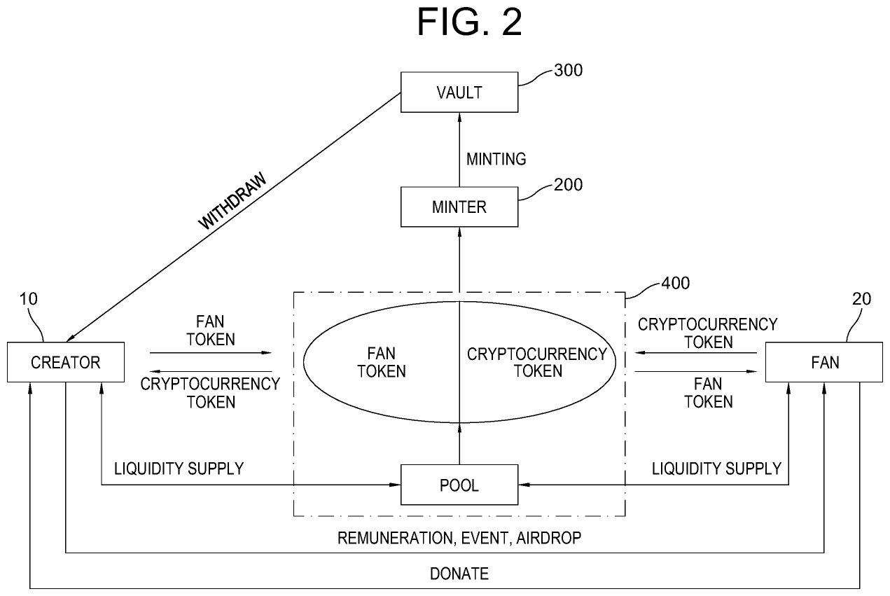

A method for issuing the fan tokens based on the blockchain network 100 through the blockchain system 1000 in accordance with one example embodiment of the present disclosure configured as above is explained as follows with reference to FIG. 2.

Firstly, a method for issuing fan tokens based on a blockchain in accordance with one example embodiment of the present disclosure is explained as follows.

A processor of at least one of the blockchain nodes in the blockchain network 100 may allow the minter 200 to mint the fan tokens as much as a preset total upper limit of issuing the fan tokens.

In addition, the blockchain system 1000 may allow the minter 200 to issue the fan tokens to the vault 300 as much as an initial issued number among the fan tokens of the preset total upper limit, thereby allowing the initial issued number of the fan tokens to be deposited in the vault 300.

In addition, the blockchain system 1000 may register information on the initial issued number of the fan tokens and thus update information on a current total issued amount of the fan tokens.

As one example, the blockchain system 1000 may register information on the initial issued number of the fan tokens corresponding to the initial issued number of the fan tokens issued to the vault 300 through the minter 200, or the blockchain system 1000 may allow the minter 200 to register information on the initial issued number of the fan tokens in the blockchain network 100, thereby updating information on the current total issued amount of the fan tokens. That is, the blockchain system 1000 may broadcast a transaction including information on the initial issued number of the fan tokens issued over the blockchain network 100, or may allow the minter 200 to broadcast a transaction including information on the initial issued number of the fan tokens over the blockchain network 100, thereby allowing the blockchain nodes constituting the blockchain network 100 to generate a block containing the transaction through a distributed consensus and thus register the block in the distributed ledger. Herein, the blockchain system 1000 may issue the initial issued number of the fan tokens according to a preset condition, e.g., an initialization condition of a system, or according to a request from a service operation node, or may allow the minter 200 to issue the initial issued number of the fan tokens according to the preset condition, e.g., the initialization condition of the system, or according to the request from the service operation node.

Thereafter, the creator 10 may withdraw the fan tokens from the vault 300 to thereby send the withdrawn fan tokens to a creator address registered in the whitelist.

As one example, the creator address may be in a state registered in the whitelist over the blockchain network 100 by the service operation node. In case there is a request for withdrawal of the fan tokens deposited in the vault 300, the blockchain system 1000 may allow the blockchain network 100 to check whether the creator address is an address registered in the whitelist, and then if the creator address is determined to be an address registered in the whitelist, the blockchain system 1000 may allow the blockchain network 100 to transmit the withdrawn number of the fan tokens to the creator address. As another example, in case there is a request for the withdrawal of the deposited fan tokens, the blockchain system 1000 allows the vault 300 to check whether the creator address is an address registered in the whitelist, and then if the creator address is determined to be an address registered in the whitelist, the blockchain system 1000 may allow the vault 300 to transmit the withdrawn number of the fan tokens to the creator address. In addition, the blockchain system 1000 may register information on the withdrawn fan tokens in the blockchain network 100, or may allow the vault 300 to register information on the withdrawn fan tokens in the blockchain network 100.

As still another example, the blockchain system 1000 may register the whitelist address itself in the vault 300, and allow the vault 300 to check whether the creator address is the address registered in the whitelist. For example, in case the vault 300 is implemented as a smart contract operated in a virtual machine over the blockchain network 100, the whitelist may be registered in the smart contract itself, to thereby allow the creator address to be checked whether it belongs to the whitelist.

Meanwhile, the creator 10 which has withdrawn the fan tokens from the vault 300 may sell the fan tokens through the liquidity pool 400, or may transmit the fan tokens to the liquidity pool 400 and thus receive interests from the liquidity pool 400. In addition, the creator 10 may 10 may provide the fan tokens to one or more fans 20 through remuneration or events, etc.

In addition, the fans 20 may purchase the fan tokens by using cryptocurrency tokens through the liquidity pool 400 as a method of supporting the creator 10. Herein, the cryptocurrency tokens may be stablecoins, but the present invention is not limited thereto, and may be various cryptocurrency tokens used in payments or various services. In addition, the fans 20 may transmit the fan tokens to the liquidity pool 400 and thus receive the interests from the liquidity pool 400. In addition, the fans 20 may transmit the fan tokens to the creator 10 in order to donate the fan tokens to the creator 10.

As explained, on condition that the exchange between the fan tokens and the cryptocurrency tokens is made through the liquidity pool 400, the blockchain system 1000 may (i) acquire price information of the fan tokens exchanged in the liquidity pool 400, (ii) allow the minter 200 to additionally issue the fan tokens to the vault 300 as much as a specific multiple of a preset unit number corresponding to a first price fluctuation condition whenever a reference price calculated by referring to the price information of the fan tokens during a preset criterion time is detected to satisfy the first price fluctuation condition, and (iii) register information on the specific multiple of the preset unit number of the fan tokens additionally issued in the blockchain network 100, thereby updating the information on the current total issued amount of the fan tokens.

Herein, the blockchain system 1000 may calculate a time-weighted average price as the reference price by referring to the price information of the fan tokens during the preset criterion time, and check whether the time-weighted average price exceeds a high-watermark which is a last highest price and whether the time-weighted average price has increased as much as a certain multiple of a preset unit price or has increased more than the certain multiple of the preset unit price from a specific criterion price among a plurality of preset criterion prices, to thereby check whether the reference price satisfies the first price fluctuation condition.

That is, the blockchain system 1000 may calculate the time-weighted average price during the preset criterion time for each period of time by referring to the price information of the fan tokens, and in case it is detected that the time-weighted average price exceeds the high-watermark and that the time-weighted average price has increased as much as the certain multiple of the preset unit price or has increased more than the certain multiple of the preset unit price from the specific criterion price corresponding to the information on the current total issued amount, the blockchain system 1000 may allow the minter 200 to further issue the fan tokens to the vault 300 as much as the specific multiple of the preset unit number which is set as corresponding to an increased cardinal number of the preset unit price of the time-weighted average price. Herein, the blockchain system 1000 may be prevented from calculating the time-weighted average price during the preset criterion time of an initial stage. In addition, the blockchain system 1000 may acquire the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool 400.

As one example, the preset criterion time is set to be 24 hours, and the period of time is set to be 1 minute, and the unit price is set to be 0.01, and the preset unit number is set to be 1,000, and this case is explained as follows.

On condition that first 1,000 fan tokens have been issued as the initial number, the blockchain system 1000 calculates the time-weighted average price (by referring to previous 24 hours) for each 1 minute from a time when 24 hours have passed, and in case it is detected that the time weighted average price exceeds the high-watermark and that the time-weighted average price has increased as much as 0.01, 0.02, 0.03, etc. from the specific criterion price among the plurality of the preset criterion prices, the blockchain system 1000 may further issue the fan tokens to the vault 300 as much as 1,000 fan tokens, another 1,000 fan tokens, still another 1,000 fan tokens, etc. Herein, the preset criterion prices may be indicated as the first criterion price of 1.00 and subsequent criterion prices increased from 1.00 by 0.01, 0.02, 0.03, etc., and the specific criterion price may be the current criterion price of the fan tokens acquired by the information on the current total issued amount of the fan tokens.

That is, the blockchain system 1000 may further issue the fan tokens in increments of 1,000 whenever the price of the fan tokens for the cryptocurrency tokens increases by 0.01 each, i.e., 0.01, 0.02, 0.03, . . . , starting from 1.00 which is the first criterion price, as the demand for the fan tokens increases. Herein, in order to prevent reckless attacks, the fan tokens may not be additionally issued simply whenever the price increases by 0.01 each, but the fan tokens may be additionally issued whenever the time-weighted average price, i.e., the average price during the previous 24 hours, exceeds the high-watermark and increases by 0.01 each.

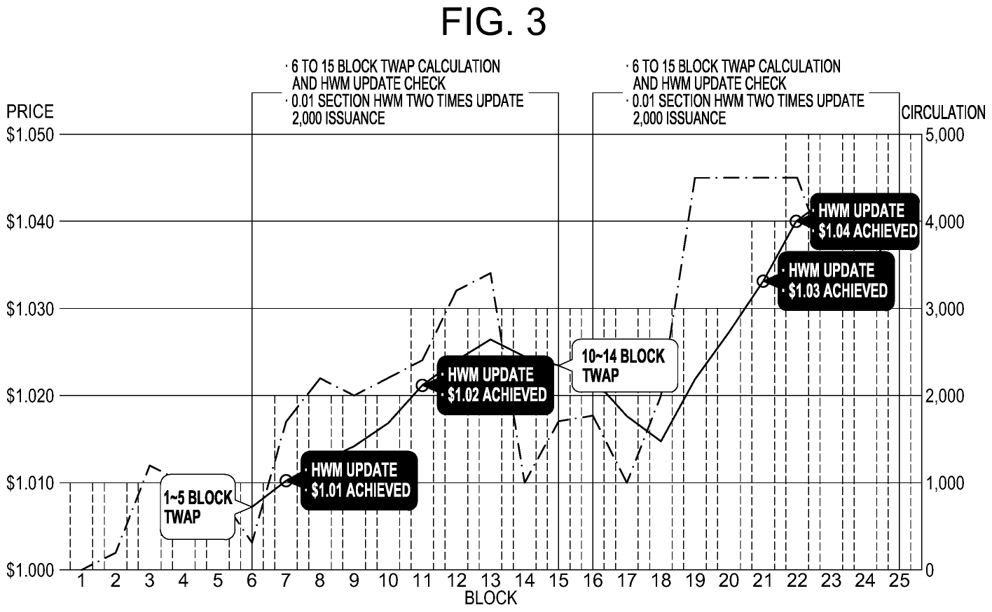

This can be explained in further detail with reference to FIG. 3 as follows.

In FIG. 3, the period of time is set as one block, the preset criterion time is set as 5 blocks, the unit price is set as 0.01, and the preset unit number is set as 1,000.

The blockchain system 1000 may set the initial criterion price of the fan tokens as 1.00, and accordingly issue the 1,000 fan tokens as the initial number of the fan tokens.

In addition, the blockchain system 1000 is prevented from calculating the time-weighted average price from a 1-st block to a 5-th block which are the initial preset criterion time.

Thereafter, the blockchain system 1000 may calculate a 6-th time-weighted average price at a 6-th block by using prices of the fan tokens at the 1-st block to the 5-th block. Herein, the 6-th time-weighted average price does not exceed 1.01 (which is calculated by adding the unit price of 0.01 to the initial criterion price of 1.00 which is the specific criterion price corresponding to 1,000 which is the current total issued amount of the fan tokens), and thus additional issuance of the fan tokens is not made and the 6-th time-weighted average price is set as the high-watermark.

In addition, the blockchain system 1000 may calculate the 7-th time-weighted average price at a 7-th block by using prices of the fan tokens of from the 2-nd block to the 6-th block. Herein, the 7-th time-weighted average price exceeds the 6-th time-weighted average price which is the high-watermark, and the 7-th time-weighted average price becomes 1.01 or more, i.e., increased by the unit price of 0.01 or more from the initial criterion price of 1.00, and thus the first price fluctuation condition is satisfied, and accordingly, the blockchain system 1000 further issues 1,000 fan tokens corresponding to 0.01 which is the increased unit price, thereby allowing the current total issued amount of the fan tokens to become 2,000. In addition, the blockchain system 1000 may update the high-watermark to the 7-th time-weighted average price, and according to the additional issuance of 1,000 fan tokens, may adjust the initial criterion price of the fan tokens such that the current criterion price of the fan tokens becomes 1.01 which is the specific criterion price corresponding to the current total issued amount of the fan tokens of 2,000.

In a similar way, each of a 8-th time-weighted average price to a 10-th time-weighted average price calculated at each of a 8-th block to a 10-th block does not correspond to a price increased by the unit price of 0.01 or more from the current criterion price of 1.01 which is the specific criterion price corresponding to the current total issued amount of 2,000, and thus the blockchain system 1000 does not further issue the fan tokens, and updates the high-watermark, and accordingly, the high-watermark in the 10-th block may be the 10-th time-weighted average price.

Thereafter, the blockchain system 1000 calculates a 11-th time-weighted average price at a 11-th block by using the price information of the fan tokens from the 6-th block to the 10-th block. Herein, the 11-th time-weighted average price exceeds the 10-th time-weighted average price which is the high-watermark, and the 11-th time-weighted average price becomes 1.02 or more, i.e., increased by the unit price of 0.01 or more from the current criterion price of 1.01 which is the specific criterion price corresponding to the current total issued amount of 2,000, and thus the first price fluctuation condition is satisfied, and accordingly, the blockchain system 1000 further issues 1,000 fan tokens corresponding to 0.01 which is the increased unit price, thereby allowing the current total issued amount of the fan tokens to become 3,000. In addition, the blockchain system 1000 may update the high-watermark to the 11-th time-weighted average price, and according to the additional issuance of 1,000 fan tokens, may re-adjust 1.01 which is the specific criterion price corresponding to the previous total issued amount of 2,000 such that the current criterion price of the fan tokens becomes 1.02 which is the specific criterion price corresponding to the current total issued amount of the fan tokens of 3,000.

In a similar way, each of a 12-th time-weighted average price to a 20-th time-weighted average price calculated at each of a 12-th block to a 20-th block does not correspond to a price increased by the unit price of 0.01 or more from the current criterion price of 1.02 which is the specific criterion price corresponding to the current total issued amount of 3,000, and thus the blockchain system 1000 does not further issue the fan tokens, and updates the high-watermark, and accordingly, the high-watermark in the 20-th block may be the 20-th time-weighted average price.

In addition, the blockchain system 1000 calculates a 21-st time-weighted average price at a 21-st block by using the price information of the fan tokens from a 16-th block to a 20-th block. Herein, the 21-st time-weighted average price exceeds the 20-th time-weighted average price which is the high-watermark, and the 21-st time-weighted average price becomes 1.03 or more, i.e., increased by the unit price of 0.01 or more from the current criterion price of 1.02 which is the specific criterion price corresponding to the current total issued amount of 3,000, and thus the first price fluctuation condition is satisfied, and accordingly, the blockchain system 1000 further issues 1,000 fan tokens corresponding to 0.01 which is the increased unit price, thereby allowing the current total issued amount of the fan tokens to become 4,000. In addition, the blockchain system 1000 may update the high-watermark to the 21-st time-weighted average price, and according to the additional issuance of 1,000 fan tokens, may re-adjust 1.02 which is the specific criterion price corresponding to the previous total issued amount of 3,000 such that the current criterion price of the fan tokens becomes 1.03 which is the specific criterion price corresponding to the current total issued amount of 4,000.

In addition, the blockchain system 1000 calculates a 22-nd time-weighted average price at a 22-nd block by using the price information of the fan tokens from the 17-th block to the 21-st block. Herein, the 22-nd time-weighted average price exceeds the 21-st time-weighted average price which is the high-watermark, and the 22-nd time-weighted average price becomes 1.04 or more, i.e., increased by the unit price of 0.01 or more from the current criterion price of 1.03 which is the specific criterion price corresponding to the current total issued amount of 4,000, and thus the first price fluctuation condition is satisfied, and accordingly, the blockchain system 1000 further issues 1,000 fan tokens corresponding to 0.01 which is the increased unit price, thereby allowing the current total issued amount of the fan tokens to become 5,000. In addition, the blockchain system 1000 may update the high-watermark to the 22-nd time-weighted average price, and according to the additional issuance of 1,000 fan tokens, may re-adjust 1.03 which is the specific criterion price corresponding to the previous total issued amount of 4,000 such that the current criterion price of the fan tokens becomes 1.04 which is the specific criterion price corresponding to the current total issued amount of the fan tokens of 5,000.

In a similar way, each of a 23-rd time-weighted average price to a 25-th time-weighted average price calculated at each of a 23-rd block to a 25-th block does not correspond to a price increased by the unit price of 0.01 or more from the current criterion price of 1.04 which is the specific criterion price corresponding to the current total issued amount of 5,000, and thus the blockchain system 1000 does not further issue the fan tokens, and updates the high-watermark, and accordingly, the high-watermark in the 25-th block may be the 23-rd time-weighted average price.

Meanwhile, in the above, for each period of time, the time-weighted average price of the fan tokens is increased by the unit price or more, and the additional issuance of the fan tokens is performed whenever the reference price is detected to satisfy the first price fluctuation condition, but in contrast, for each of grouping cycle for additional issuance, the fan tokens may be additionally issued.

That is, the blockchain system 1000 may calculate time-weighted average prices during the criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the certain multiple of the preset unit price or has increased more than the certain multiple of the preset unit price from the specific criterion price corresponding to the information on the current total issued amount, the blockchain system 1000 may further issue the fan tokens to the vault 300 as much as the specific multiple of the preset unit number which is set as corresponding to an increased cardinal number of the preset unit price of the specific time-weighted average price.

As one example, it can be explained with reference to FIG. 3 as follows.

Herein, the period of time is set as one block, the preset criterion time is set as 5 blocks, the unit price is set as 0.01, and the preset unit number is set as 1,000, and the grouping cycle for additional issuance may be set as 10 blocks.

The blockchain system 1000 may set the initial criterion price of the initial fan tokens to be 1.00, and issue the initial 1,000 fan tokens as much as the initial number of the fan tokens.

In addition, the blockchain system 1000 is prevented from calculating the time-weighted average price from the 1-st block to the 5-th block which are the initial preset criterion time.

Thereafter, the blockchain system 1000 may perform operation of calculating the 6-th time-weighted average price starting from the 6-th block by using the price information of the fan tokens from the 1-st block to the 5-th block.

In addition, in case the current block becomes a 15-th block which is the 10-th block (i.e., the grouping cycle for additional issuance) starting from the 6-th block, the blockchain system 1000 checks whether there is any time-weighted average price which satisfies the first price fluctuation condition, that is, which exceeds the high-watermark and which has increased as much as a certain multiple of the preset unit price or has increased more than the certain multiple of the preset unit price, among the 6-th time-weighted average price to the 15-th time-weighted average price calculated at from the 6-th block to the 15-th block.

Herein, the time-weighted average price which satisfies the first price fluctuation condition among the 6-th time-weighted average price to the 15-th time-weighted average price are the 7-th time-weighted average price at the 7-th block and the 11-th time-weighted average price at the 11-th block, and thus the blockchain system 1000 may further issue 2,000 fan tokens which is as much as the specific multiple of the preset unit number which is set as corresponding to an increased cardinal number of the preset unit price of the time-weighted average price, to allow the current total issued amount of the fan tokens to become 3,000. In addition, the blockchain system 1000 may adjust the current criterion price such that the specific criterion price of 1.00 corresponding to the previous total issued amount of 1,000 is adjusted to be the specific criterion price of 1.02 corresponding to the current total issued amount of 3,000.

Thereafter, in case the current block becomes a 25-th block which is the 10-th block (i.e., the grouping cycle for additional issuance) starting from the 16-th block, the blockchain system 1000 checks whether there is any time-weighted average price which satisfies the first price fluctuation condition, that is, which exceeds the high-watermark and which has increased as much as a certain multiple of the preset unit price or has increased more than the certain multiple of the preset unit price, among the 16-th time-weighted average price to the 25-th time-weighted average price calculated at from the 16-th block to the 25-th block.

Herein, the time-weighted average price which satisfies the first price fluctuation condition among the 16-th time-weighted average price to the 25-th time-weighted average price are the 21-st time-weighted average price at the 21-st block and the 22-nd time-weighted average price at the 22-nd block, and thus the blockchain system 1000 may further issue 2,000 fan tokens which is as much as the specific multiple of the preset unit number which is set as corresponding to an increased cardinal number of the preset unit price of the time-weighted average price, to allow the current total issued amount of the fan tokens to become 5,000. In addition, the blockchain system 1000 may adjust the current criterion price such that the specific criterion price of 1.02 corresponding to the previous total issued amount of 3,000 is adjusted to be the specific criterion price of 1.04 corresponding to the current total issued amount of 5,000.

In the above, the blockchain system 1000 has checked whether the time-weighted average prices for each period of time included in each of the grouping cycle for additional issuance satisfy the first price fluctuation condition, but in contrast, the blockchain system 1000 may check whether there is a high-watermark in the grouping cycle for additional issuance, and if there is the high-watermark in the grouping cycle for additional issuance, the blockchain system 1000 may check whether the first price fluctuation condition is satisfied, and if the first price fluctuation condition is satisfied, the blockchain system 1000 may issue the fan tokens.

That is, in case the current block becomes the 15-th block, the blockchain system 1000 may check the time-weighted average prices at the 6-th block to the 15-th block, and may check that the 13-th time-weighted average price at the 13-th block is the high-watermark.

Herein, the 13-th time-weighted average price is 1.02 or more, that is, the blockchain system 1000 has updated the unit price of 0.01 two times from the current criterion price of 1.00 which is the specific criterion price corresponding to 1,000 which is the current total issued amount of the fan tokens, and thus the blockchain system 1000 may further issue 2,000 fan tokens corresponding to two times of the unit price. In addition, according to the additional issuance of 2,000 fan tokens, the blockchain system 1000 may adjust the current criterion price of the fan tokens such that the specific criterion price of 1.00 corresponding to the previous total issued amount of 1,000 to become the specific criterion price of 1.02 corresponding to the current total issued amount of 3,000.

In addition, in case the current block becomes the 25-th block, the blockchain system 1000 may check the time-weighted average prices in the 16-th block to the 25-th block, and may check that the 23-rd time-weighted average price at the 23-rd block is the high-watermark.

Herein, the 23-rd time-weighted average price is 1.04 or more, that is, the blockchain system 1000 has updated the unit price of 0.01 two times from the current criterion price of 1.02, and thus the blockchain system 1000 may further issue 2,000 fan tokens corresponding to two times of the unit price. In addition, according to the additional issuance of 2,000 fan tokens, the blockchain system 1000 may adjust the current criterion price of the fan tokens such that the specific criterion price of 1.02 corresponding to the previous total issued amount of 3,000 to become the specific criterion price of 1.04 corresponding to the current total issued amount of 5,000.

Next, a method for issuing the fan tokens based on blockchain in accordance with another example embodiment of the present disclosure is explained with reference to FIG. 2 as follows. In the following description, detailed explanation on parts that can be easily understood from the description provided by explanation above will be omitted.

On condition that a total upper limit of issuing the fan tokens has been set, the blockchain system 1000 may allow the minter 200 to mint the fan tokens as much as a preset initial minted number, allow the minter 200 to issue the fan tokens to the vault 300 as much as the preset initial minted number, and allow the preset initial minted number of the fan tokens to be deposited in the vault 300. In addition, the blockchain system 1000 may register information on the initial minted number of the fan tokens in the blockchain network 100 and thus update information on a current total issued amount of the fan tokens.

As one example, the blockchain system 1000 may register information on the initial minted number of the fan tokens, or the blockchain system 1000 may allow the minter 200 to register information on the initial minted number of the fan tokens in the blockchain network 100. Accordingly, the blockchain system 1000 may update information on the current total issued amount of the fan tokens.

Thereafter, the creator 10 may withdraw the fan tokens from the vault 300 to thereby send the withdrawn fan tokens to the creator address registered in the whitelist and distribute them.

In addition, when exchanges between the fan tokens and the cryptocurrency tokens are made through the liquidity pool 400, the blockchain system 1000 may acquire the price information of the fan tokens exchanged in the liquidity pool 400, allow the minter 200 to additionally mint the fan tokens as much as a specific multiple of a preset unit number corresponding to a second price fluctuation condition and then to issue the minted fan tokens to the vault 300 whenever a reference price during the preset criterion time is detected to satisfy the second price fluctuation condition, and registering information on the specific multiple of the preset unit number of the fan tokens additionally minted in the blockchain network 100, thereby updating the information on the current total issued amount of the fan tokens.

Herein, the blockchain system 1000 may calculate, as the reference price, a time-weighted average price (during the preset criterion time) by referring to the price information of the fan tokens, and check whether the time-weighted average price exceeds a high-watermark which is a last highest price and whether the time-weighted average price has increased as much as a certain multiple of the preset unit price or has increased more than the certain multiple of the preset unit price from the specific criterion price among a plurality of preset criterion prices, to thereby check whether the reference price satisfies the second price fluctuation condition.

That is, the blockchain system 1000 may calculate the time-weighted average price during the preset criterion time for each period of time by referring to the price information of the fan tokens, and in case it is detected that the time-weighted average price exceeds the high-watermark and that the time-weighted average price has increased as much as the certain multiple of the preset unit price or has increased more than the certain multiple of the preset unit price from the specific criterion price corresponding to the information on the current total issued amount, the blockchain system 1000 may allow the minter 200 to additionally mint the fan tokens as much as the specific multiple of the preset unit number which is set as corresponding to an increased cardinal number of the preset unit price of the time-weighted average price. Herein, the blockchain system 1000 may be prevented from calculating the time-weighted average price during the preset criterion time of an initial stage. In addition, the blockchain system 1000 may acquire the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool 400.

On the assumption that the preset criterion time is set as 24 hours, and the period of time is set as 1 minute, and the unit price is set as 0.01, and the preset unit number is set as 1,000, an example of another example embodiment of the present disclosure is explained as follows.

On condition that initial 1,000 fan tokens have been issued, the blockchain system 1000 calculates the time-weighted average price (by referring to previous 24 hours) for each 1 minute from a time when 24 hours have passed, and in case it is detected that the time weighted average price exceeds the high-watermark and that the time-weighted average price has increased as much as 0.01, 0.02, 0.03, etc. from the specific criterion price among the plurality of the preset criterion prices, the blockchain system 1000 may further mint the fan tokens and then issue the minted fan tokens as much as 1,000 fan tokens, another 1,000 fan tokens, still another 1,000 fan tokens, etc. Herein, the plurality of preset criterion prices may be indicated as the first criterion price of 1.00 and subsequent criterion prices increased from 1.00 by 0.01, 0.02, 0.03, etc., and the specific criterion price may be the current criterion price of the fan tokens acquired by the information on the current total issued amount of the fan tokens.

That is, the blockchain system 1000 may further mint and then issue the fan tokens in increments of 1,000 whenever the price of the fan tokens for the cryptocurrency tokens increases by 0.01 each, i.e., 0.01, 0.02, 0.03, . . . , starting from 1.00 which is the first criterion price, as the demand for the fan tokens increases. Herein, in order to prevent reckless attacks, the fan tokens may not be additionally minted and then issued simply whenever the price increases by 0.01 each, but the fan tokens may be additionally minted and then issued whenever the time-weighted average price, i.e., the average price during the previous 24 hours, exceeds the high-watermark and increases by 0.01 each.

This can be explained in further detail with reference to FIG. 3 as follows.

In FIG. 3, the period of time is set as one block, the preset criterion time is set as 5 blocks, the unit price is set as 0.01, and the preset unit number is set as 1,000.

The blockchain system 1000 may set the initial criterion price of the first fan tokens as 1.00, and accordingly mint and then issue the first 1,000 fan tokens as the initial number of the fan tokens.

In addition, the blockchain system 1000 is prevented from calculating the time-weighted average price from the 1-st block to the 5-th block which are the initial preset criterion time.

Thereafter, the blockchain system 1000 may calculate the 6-th time-weighted average price at the 6-th block by using prices of the fan tokens at the 1-st block to the 5-th block. Herein, the 6-th time-weighted average price does not exceed 1.01 (which is calculated by adding the unit price of 0.01 to the initial criterion price of 1.00 which is the specific criterion price corresponding to 1,000 which is the current total issued amount of the fan tokens), and thus additional minting of the fan tokens is not made for the fan tokens, and the 6-th time-weighted average price is set as the high-watermark.

In addition, the blockchain system 1000 may calculate the 7-th time-weighted average price at the 7-th block by using prices of the fan tokens of from the 2-nd block to the 6-th block. Herein, the 7-th time-weighted average price exceeds the 6-th time-weighted average price which is the high-watermark, and the 7-th time-weighted average price becomes 1.01 or more, i.e., increased by the unit price of 0.01 or more from the initial criterion price of 1.00, and thus the second price fluctuation condition is satisfied, and accordingly, the blockchain system 1000 further mints and then issues 1,000 fan tokens corresponding to 0.01 which is the increased unit price, thereby allowing the current total issued amount of the fan tokens to become 2,000. In addition, the blockchain system 1000 may update the high-watermark to the 7-th time-weighted average price, and according to the additional minting of 1,000 fan tokens, may adjust the initial criterion price of the fan tokens such that the current criterion price of the fan tokens becomes 1.01 which is the specific criterion price corresponding to the current total issued amount of the fan tokens of 2,000.

In a similar way, each of the 8-th time-weighted average price to the 10-th time-weighted average price calculated at each of the 8-th block to the 10-th block does not correspond to a price increased by the unit price of 0.01 or more from the current criterion price of 1.01 which is the specific criterion price corresponding to the current total issued amount of 2,000, and thus the blockchain system 1000 does not further mint the fan tokens, and updates the high-watermark, and accordingly, the high-watermark in the 10-th block may be the 10-th time-weighted average price.

Thereafter, the blockchain system 1000 calculates the 11-th time-weighted average price at the 11-th block by using the price information of the fan tokens from the 6-th block to the 10-th block. Herein, the 11-th time-weighted average price exceeds the 10-th time-weighted average price which is the high-watermark, and the 11-th time-weighted average price becomes 1.02 or more, i.e., increased by the unit price of 0.01 or more from the current criterion price of 1.01 which has been adjusted, and thus the second price fluctuation condition is satisfied, and accordingly, the blockchain system 1000 further mints and then issues 1,000 fan tokens corresponding to 0.01 which is the increased unit price, thereby allowing the current total issued amount of the fan tokens to become 3,000. In addition, the blockchain system 1000 may update the high-watermark to the 11-th time-weighted average price, and according to the additional minting of 1,000 fan tokens, may re-adjust 1.01 which is the specific criterion price corresponding to the previous total issued amount of 2,000 such that the current criterion price of the fan tokens becomes 1.02 which is the specific criterion price corresponding to the current total issued amount of the fan tokens of 3,000.

In a similar way, each of the 12-th time-weighted average price to the 20-th time-weighted average price calculated at each of the 12-th block to the 20-th block does not correspond to a price increased by the unit price of 0.01 or more from the specific criterion price of 1.02 corresponding to the current total issued amount of 3,000, and thus the blockchain system 1000 does not further mint the fan tokens, and updates the high-watermark, and accordingly, the high-watermark in the 20-th block may be the 20-th time-weighted average price.

In addition, the blockchain system 1000 calculates the 21-st time-weighted average price at the 21-st block by using the price information of the fan tokens from the 16-th block to the 20-th block. Herein, the 21-st time-weighted average price exceeds the 20-th time-weighted average price which is the high-watermark, and the 21-st time-weighted average price becomes 1.03 or more, i.e., increased by the unit price of 0.01 or more from the current criterion price of 1.02 which is the specific criterion price corresponding to the current total issued amount of 3,000, and thus the first price fluctuation condition is satisfied, and accordingly, the blockchain system 1000 further mints and then issues 1,000 fan tokens corresponding to 0.01 which is the increased unit price, thereby allowing the current total issued amount of the fan tokens to become 4,000. In addition, the blockchain system 1000 may update the high-watermark to the 21-st time-weighted average price, and according to the additional minting of 1,000 fan tokens, may re-adjust 1.02 which is the specific criterion price corresponding to the previous total issued amount of 3,000 such that the current criterion price of the fan tokens becomes 1.03 which is the specific criterion price corresponding to the current total issued amount of 4,000.

In addition, the blockchain system 1000 calculates the 22-nd time-weighted average price at the 22-nd block by using the price information of the fan tokens from the 17-th block to the 21-st block. Herein, the 22-nd time-weighted average price exceeds the 21-st time-weighted average price which is the high-watermark, and the 22-nd time-weighted average price becomes 1.04 or more, i.e., increased by the unit price of 0.01 or more from the specific criterion price of 1.03 corresponding to the previous total issued amount of 4,000, and thus the first price fluctuation condition is satisfied, and accordingly, the blockchain system 1000 further mints and then issues 1,000 fan tokens corresponding to 0.01 which is the increased unit price, thereby allowing the current total issued amount of the fan tokens to become 5,000. In addition, the blockchain system 1000 may update the high-watermark to the 22-nd time-weighted average price, and according to the additional minting of 1,000 fan tokens, may re-adjust 1.03 which is the specific criterion price corresponding to the previous total issued amount of 4,000 such that the current criterion price of the fan tokens becomes 1.04 which is the specific criterion price corresponding to the current total issued amount of the fan tokens of 5,000.

In a similar way, each of the 23-rd time-weighted average price to the 25-th time-weighted average price calculated at each of the 23-rd block to the 25-th block does not correspond to a price increased by the unit price of 0.01 or more from the current criterion price of 1.04 which is the specific criterion price corresponding to the current total issued amount of 5,000, and thus the blockchain system 1000 does not further mint the fan tokens, and updates the high-watermark, and accordingly, the high-watermark in the 25-th block may be the 23-rd time-weighted average price.

Meanwhile, in the above, for each period of time, the time-weighted average price of the fan tokens is increased by the unit price or more, and the additional minting of the fan tokens is performed whenever the reference price is detected to satisfy the second price fluctuation condition, but in contrast, for each of grouping cycle for additional issuance, the fan tokens may be additionally minted.

That is, the blockchain system 1000 may calculate time-weighted average prices during the criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the certain multiple of the preset unit price or has increased more than the certain multiple of the preset unit price from the specific criterion price corresponding to the information on the current total issued amount, the blockchain system may allow the minter 200 to additionally mint the fan tokens and to issue the minted fan tokens to the vault 300 as much as the specific multiple of the preset unit number which is set as corresponding to an increased cardinal number of the preset unit price of the specific time-weighted average price.

As one example, it can be explained with reference to FIG. 3 as follows.

Herein, the period of time is set as one block, the preset criterion time is set as 5 blocks, the unit price is set as 0.01, and the preset unit number is set as 1,000, and the grouping cycle for additional issuance may be set as 10 blocks.

The blockchain system 1000 may set the initial criterion price of the initial fan tokens to be 1.00, and mint and then issue the initial 1,000 fan tokens as much as the initial number of the fan tokens.

In addition, the blockchain system 1000 is prevented from calculating the time-weighted average price from the 1-st block to the 5-th block which are the initial preset criterion time.

Thereafter, the blockchain system 1000 may perform operation of calculating the 6-th time-weighted average price starting from the 6-th block by using the price information of the fan tokens from the 2-nd block to the 5-th block.

In addition, in case the current block becomes the 15-th block which is the 10-th block (i.e., the grouping cycle for additional issuance) starting from the 6-th block, the blockchain system 1000 checks whether there is any time-weighted average price which satisfies the second price fluctuation condition, that is, which exceeds the high-watermark and which has increased as much as a certain multiple of the preset unit price or has increased more than the certain multiple of the preset unit price, among the 6-th time-weighted average price to the 15-th time-weighted average price calculated at from the 6-th block to the 15-th block.

Herein, the time-weighted average price which satisfies the second price fluctuation condition among the 6-th time-weighted average price to the 15-th time-weighted average price are the 7-th time-weighted average price at the 7-th block and the 11-th time-weighted average price at the 11-th block, and thus the blockchain system 1000 may further mint 2,000 fan tokens which is as much as the specific multiple of the preset unit number which is set as corresponding to an increased cardinal number of the preset unit price of the time-weighted average price, to allow the current total issued amount of the fan tokens to become 3,000. In addition, the blockchain system 1000 may adjust the current criterion price such that the specific criterion price of 1.00 corresponding to the previous total issued amount of 1,000 is adjusted to be the specific criterion price of 1.02 corresponding to the current total issued amount of 3,000.

Thereafter, in case the current block becomes the 25-th block which is the 10-th block (i.e., the grouping cycle for additional issuance) starting from the 16-th block, the blockchain system 1000 checks whether there is any time-weighted average price which satisfies the second price fluctuation condition, that is, which exceeds the high-watermark and which has increased as much as a certain multiple of the preset unit price or has increased more than the certain multiple of the preset unit price, among the 16-th time-weighted average price to the 25-th time-weighted average price calculated at from the 16-th block to the 25-th block.

Herein, the time-weighted average price which satisfies the second price fluctuation condition among the 16-th time-weighted average price to the 25-th time-weighted average price are the 21-st time-weighted average price at the 21-st block and the 22-nd time-weighted average price at the 22-nd block, and thus the blockchain system 1000 may further mint and then issue 2,000 fan tokens which is as much as the specific multiple of the preset unit number which is set as corresponding to an increased cardinal number of the preset unit price of the time-weighted average price, to allow the current total issued amount of the fan tokens to become 5,000. In addition, the blockchain system 1000 may adjust the current criterion price such that the specific criterion price of 1.02 corresponding to the previous total issued amount of fan tokens being 3,000 is adjusted to be the specific criterion price of 1.04 corresponding to the current total issued amount of 5,000.

In the above, the blockchain system 1000 has checked whether the time-weighted average prices for each period of time included in each of the grouping cycle for additional issuance satisfy the second price fluctuation condition, but in contrast, the blockchain system 1000 may check whether there is a high-watermark in the grouping cycle for additional issuance, and if there is the high-watermark in the grouping cycle for additional issuance, the blockchain system may check whether the second price fluctuation condition is satisfied, and if the second price fluctuation condition is satisfied, the blockchain system 1000 may issue the fan tokens.

That is, in case the current block becomes the 15-th block, the blockchain system 1000 may check the time-weighted average prices at the 6-th block to the 15-th block, and may check that the 13-th time-weighted average price in the 13-th block is the high-watermark.

Herein, the 13-th time-weighted average price is 1.02 or more, that is, the blockchain system 1000 has updated the unit price of 0.01 two times from the current criterion price of 1.00 which is the specific criterion price corresponding to 1,000 which is the current total issued amount of the fan tokens, and thus the blockchain system 1000 may further mint and then issue 2,000 fan tokens corresponding to two times of the unit price. In addition, according to the additional issuance of 2,000 fan tokens, the blockchain system 1000 may adjust the current criterion price of the fan tokens such that the specific criterion price of 1.00 corresponding to the previous total issued amount of 1,000 to become the specific criterion price of 1.02 corresponding to the current total issued amount of 3,000.

In addition, in case the current block becomes the 25-th block, the blockchain system 1000 may check the time-weighted average prices in the 16-th block to the 25-th block for the 25-th block, and may check that the 23-rd time-weighted average price at the 23-rd block is the high-watermark.

Herein, the 23-rd time-weighted average price is 1.04 or more, that is, the blockchain system 1000 has updated the unit price of 0.01 two times from the current criterion price of 1.02, and thus the blockchain system 1000 may further issue 2,000 fan tokens corresponding to two times of the unit price. In addition, according to the additional issuance of 2,000 fan tokens, the blockchain system 1000 may adjust the current criterion price of the fan tokens such that the specific criterion price of 1.02 corresponding to the previous total issued amount of 3,000 to become the specific criterion price of 1.04 corresponding to the current total issued amount of fan tokens being 5,000.

Meanwhile, in the above, it has been explained that the fan tokens are additionally minted and issued whenever the reference price of the fan tokens is detected to satisfy the second price fluctuation condition, but the issued fan tokens may be burnt to stabilize the price of the fan tokens whenever the reference price satisfies a third price fluctuation condition.

That is, the blockchain system 1000 allows the creator 10 to transmit the fan tokens to the minter 200 as much as a particular multiple of the preset unit number corresponding to a third price fluctuation condition whenever the reference price is detected to satisfy the third price fluctuation condition, and allows the minter 200 to burn the particular multiple of the preset unit number of the fan tokens transmitted from the creator 10, and registers information on the particular multiple of the preset unit number of the fan tokens burnt, thereby updating information on the current total issued amount of the fan tokens.

Herein, the blockchain system 1000 may check whether the time-weighted average price is maintained for at least a preset time after the time-weighted average price has decreased as much as the certain multiple of the preset unit price or has decreased more than the certain multiple of the preset unit price from the specific criterion price, in order to check whether the reference price satisfies the third price fluctuation condition.

Accordingly, the blockchain system 1000 may calculate the time-weighted average price during the preset criterion time for each period of time included in each of the grouping cycle for additional issuance by referring to the price information of the fan tokens in the liquidity pool 400, and (i) in case the time-weighted average price (i-1) exceeds the high-watermark and (i-2) has increased as much as the certain multiple of the preset unit price or has increased more than the certain multiple of the preset unit price from the specific criterion price corresponding to the information on the current total issued amount, the blockchain system 1000 allows the minter 200 to additionally mint the fan tokens as much as a first specific multiple of the preset unit number which is set as corresponding to an increased cardinal number of the preset unit price of the time-weighted average price and then to issue the minted fan tokens to the vault 300. In addition, (ii) in case the time-weighted average price is maintained for at least a preset time after the time-weighted average price has decreased as much as the certain multiple of the preset unit price or has decreased more than the certain multiple of the preset unit price from the specific criterion price, the blockchain system 1000 may allow the creator 10 to transmit the fan tokens to the minter 200 as much as a second specific multiple of the preset unit number which is set as corresponding to a decreased cardinal number of the preset unit price of the time-weighted average price, and allow the minter 200 to burn the second specific multiple of the preset unit number of the fan tokens transmitted from the creator 10.

In addition, the blockchain system 1000 may calculate time-weighted average prices during the preset criterion time for each period of time included in each of the grouping cycle for additional issuance by referring to the price information of the fan tokens, and in case it is detected that there is a specific time-weighted average price, among the time-weighted average prices, which exceeds the high-watermark and which has increased as much as the certain multiple of the preset unit price or has increased more than the certain multiple of the preset unit price from the specific criterion price corresponding to the information on the current total issued amount, the blockchain system 1000 may allow the minter 200 to further mint and then issue the fan tokens to the vault 300 as much as the first specific multiple of the preset unit number which is set as corresponding to an increased cardinal number of the preset unit price of the specific time-weighted average price. In addition, in case the time-weighted average prices are maintained for at least a preset time after the time-weighted average prices have decreased as much as the certain multiple of the preset unit price or have decreased more than the certain multiple of the preset unit price from the specific criterion price, the blockchain system 1000 may allow the creator 10 to transmit the fan tokens to the minter 200 as much as the second specific multiple of the preset unit number which is set as corresponding to a decreased cardinal number of the preset unit price of the time-weighted average price, and allow the minter 200 to burn the second specific multiple of the preset unit number of the fan tokens transmitted from the creator 10.

As one example, after the 25-th block in FIG. 3, in case the time-weighted average prices of the fan tokens calculated at the 26-th block or its subsequent blocks are maintained for at least 20 blocks between the criterion price of 1.02 and the criterion price of 1.03, since the time-weighted average prices of the fan tokens have decreased by 0.02 or more which is 2 unit prices from the current criterion price of 1.04 which is the specific criterion price corresponding to the current total issued amount of 5,000, the blockchain system 1000 may allow 2,000 fan tokens corresponding to the 2 unit prices to be transmitted from the creator 10 to the minter 200, and may allow the minter 200 to burn the 2,000 fan tokens. In addition, the blockchain system 1000 may 1000 may adjust the current criterion price of the fan tokens such that the current criterion price of the fan tokens becomes 1.02 which is the specific criterion price corresponding to the current total issued amount of 3,000, and the high-watermark becomes 1.02 which is the current criterion price adjusted.

In addition, in the above, the fan tokens can be burnt as much as the second specific multiple of the preset unit number which is set as corresponding to the decreased cardinal number of the preset unit price of the time-weighted average prices of fan tokens, but in order to prevent rapid fluctuation in the issued amount of the fan tokens, only part of the decreased unit prices may be applied to burn the fan tokens. That is, in the above, 2,000 fan tokens corresponding to the 2 unit prices can be burnt, but as another example, only 1,000 fan tokens corresponding to 1 unit price, i.e., a half of the 2 unit prices, may be allowed to be burnt. Herein, in response to burning of the fan tokens, the blockchain system 1000 may adjust the current criterion price of the fan tokens to be 1.03 which is the specific criterion price corresponding to the current total issued amount of 4,000, and may set the high-watermark to be 1.03.

For reference, in accordance with the present invention, the burning process is not an essential configuration, and the burning process may be added or not according to service policies.

Accordingly, the present invention does not adopt the price of the fan tokens fluctuating temporarily but adopt the average price over time, and thus the stability of the issuance of the fan tokens may be pursued.

In addition, unlike the conventional art where the distributed amount of the fan tokens naturally increases over time, the issued amount of the fan tokens is controlled depending on the demand for the fan tokens according to the present invention, thereby preventing inflation of the fan tokens.

In addition, the present invention allows anyone to check the issued amount of the fan tokens, and allows anyone to check how much the creator 10 has distributed, and thus a transparency of the fan community, that is a transparency of the creator fandom can be secured.

In addition, the additionally issued fan tokens according to the price rise can be withdrawn only by the creator 10, and thus the creator 10 can manage the fan tokens by itself.

For reference, according to the present invention, the terms such as “specific multiple”, “certain multiple” and “particular multiple” may be 2, 3, 4, etc. but it is not limited thereto. That is, the terms such as “specific multiple”, “certain multiple” and “particular multiple” may be 1 as the case may be.

The present disclosure has an effect of guaranteeing a reliability for the fan tokens by accurately informing the amount of distribution of the fan tokens.

The present disclosure has another effect of preventing the inflation of the fan tokens by controlling the issued amount of the fan tokens in response to the price fluctuation.

The present disclosure has still another effect of allowing the creator to control the distribution of the fan tokens issued.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled human in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high level code that can be used by an interpreter etc., which is executed by a computer. The aforementioned hardware device may work as more than a software module to perform the action of the present disclosure and they may do the same in the opposite case.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for issuing one or more fan tokens based on a blockchain network, comprising steps of:
(a) a blockchain system allowing a minter to mint fan tokens as much as a preset total upper limit of issuing the fan tokens, allowing the minter to issue the fan tokens to a vault as much as an initial issued number among the fan tokens of the preset total upper limit, and allowing a creator to distribute the fan tokens deposited in the vault, thereby registering information on the initial issued number of the fan tokens and thus updating information on a current total issued amount of the fan tokens; and
(b) the blockchain system acquiring price information of the fan tokens exchanged in a liquidity pool, allowing the minter to additionally issue the fan tokens to the vault as much as a specific multiple of a preset unit number corresponding to a first price fluctuation condition whenever a reference price calculated by referring to the price information of the fan tokens during a preset criterion time is detected to satisfy the first price fluctuation condition, and registering information on the specific multiple of the preset unit number of the fan tokens additionally issued, thereby updating the information on the current total issued amount of the fan tokens.

2. The method of claim 1, wherein, at the step of (b), the blockchain system calculates a time-weighted average price by referring to the price information of the fan tokens as the reference price during the preset criterion time, and checks whether the time-weighted average price exceeds a high-watermark which is a last highest price and whether the time-weighted average price has increased as much as a certain multiple of a preset unit price or has increased more than the certain multiple of the preset unit price from a specific criterion price among a plurality of preset criterion prices, to thereby check whether the reference price satisfies the first price fluctuation condition.

3. The method of claim 2, wherein, at the step of (b), the blockchain system calculates the time-weighted average price during the preset criterion time for each period of time by referring to the price information of the fan tokens, and in case it is detected that the time-weighted average price exceeds the high-watermark and that the time-weighted average price has increased as much as the certain multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the time-weighted average price.

4. The method of claim 3, wherein, at the step of (b), the blockchain system acquires the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool.

5. The method of claim 2, wherein, at the step of (b), the blockchain system calculates time-weighted average prices during the preset criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the certain multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the specific time-weighted average price.

6. The method of claim 2, wherein, at the step of (b), the blockchain system is prevented from calculating the time-weighted average price during the preset criterion time of an initial stage.

7. The method for issuing one or more fan tokens based on a blockchain network, comprising steps of:
(a) on condition that a total upper limit of issuing fan tokens has been set, a blockchain system allowing a minter to mint the fan tokens as much as a preset initial minted number, allowing the minter to issue the fan tokens to a vault as much as the preset initial minted number, and allowing a creator to distribute the fan tokens deposited in the vault, thereby registering information on the initial minted number of the fan tokens and thus updating information on a current total issued amount of the fan tokens; and
(b) the blockchain system acquiring price information of the fan tokens exchanged in a liquidity pool, calculating a reference price by referring to the price information of the fan tokens during a preset criterion time, allowing the minter to additionally mint the fan tokens as much as a specific multiple of a preset unit number corresponding to a second price fluctuation condition and then to issue the minted fan tokens to the vault whenever the reference price is detected to satisfy the second price fluctuation condition, and registering information on the specific multiple of the preset unit number of the fan tokens additionally minted, thereby updating the information on the current total issued amount of the fan tokens.

8. The method of claim 7, wherein, at the step of (b), the blockchain system calculates a time-weighted average price by referring to the price information of the fan tokens as the reference price during the preset criterion time, and checks whether the time-weighted average price exceeds a high-watermark which is a last highest price and whether the time-weighted average price has increased as much as a certain multiple of a preset unit price or has increased more than the certain multiple of the preset unit price from a specific criterion price among a plurality of preset criterion prices, to thereby check whether the reference price satisfies the second price fluctuation condition.

9. The method of claim 8, wherein, at the step of (b), the blockchain system calculates the time-weighted average price during the preset criterion time for each period of time by referring to the price information of the fan tokens, and in case it is detected that the time-weighted average price exceeds the high-watermark and that the time-weighted average price has increased as much as the certain multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the time-weighted average price.

10. The method of claim 8, wherein, at the step of (b), the blockchain system calculates time-weighted average prices during the preset criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the certain multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the specific time-weighted average price.

11. The method of claim 7, wherein, at the step of (b), the blockchain system allows the creator to transmit the fan tokens to the minter as much as a particular multiple of the preset unit number corresponding to a third price fluctuation condition whenever the reference price is detected to satisfy the third price fluctuation condition, and allows the minter to burn the particular multiple of the preset unit number of the fan tokens transmitted from the creator, and registers information on the particular multiple of the preset unit number of the fan tokens burnt, thereby updating information on the current total issued amount of the fan tokens.

12. The method of claim 11, wherein, at the step of (b), the blockchain system calculates a time-weighted average price by referring to the price information of the fan tokens as the reference price during the preset criterion time, and checks whether the time-weighted average price is maintained for at least a preset time after the time-weighted average price has decreased as much as a certain multiple of a preset unit price or has decreased more than the certain multiple of the preset unit price from a specific criterion price, to thereby check whether the reference price satisfies the third price fluctuation condition.

13. The method of claim 12, wherein, at the step of (b), the blockchain system calculates the time-weighted average price during the preset criterion time for each period of time included in each of grouping cycle for additional issuance by referring to the price information of the fan tokens, and (i) in case the time-weighted average price (i-1) exceeds the high-watermark and (i-2) has increased as much as the certain multiple of the preset unit price or has increased more than the certain multiple of the preset unit price from the specific criterion price corresponding to the information on the current total issued amount, the blockchain system allows the minter to additionally mint the fan tokens as much as a first specific multiple of the preset unit number which is set as corresponding to an increased cardinal number of the preset unit price of the time-weighted average price and then to issue the minted fan tokens to the vault, and (ii) in case the time-weighted average price is maintained for at least a preset time after the time-weighted average price has decreased as much as the certain multiple of the preset unit price or has decreased more than the certain multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average price, and allows the minter to burn the second specific multiple of the preset unit number of the fan tokens transmitted from the creator.

14. The method of claim 13, wherein, at the step of (b), the blockchain system acquires the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool.

15. The method of claim 12, wherein, at the step of (b), the blockchain system calculates time-weighted average prices during the preset criterion time for each period of time included in each of grouping cycle for additional issuance by referring to the price information of the fan tokens, and in case (i) it is detected that there is a specific time-weighted average price which exceeds the high-watermark and which has increased as much as the certain multiple of the preset unit price or has increased more than the certain multiple of the preset unit price from the specific criterion price corresponding to the information on the current total issued amount, the blockchain system allows the minter to further mint the fan tokens as much as a first specific multiple of the preset unit number which is set as corresponding to an increased cardinal number of the preset unit price of the specific time-weighted average price, and then to issue the minted fan tokens to the vault, and (ii) in case the time-weighted average prices are maintained for at least a preset time after the time-weighted average prices have decreased as much as the certain multiple of the preset unit price or have decreased more than the certain multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average prices, and allows the minter to burn the second specific multiple of the preset unit number of the fan tokens transmitted from the creator.

16. The method of claim 12, wherein, at the step of (b), the blockchain system is prevented from calculating the time-weighted average price during the preset criterion time of an initial stage.

17. A blockchain system for issuing one or more fan tokens based on a blockchain network, comprising at least one blockchain node comprising:
at least one memory that stores instructions; and
at least one processor configured to execute the instructions to perform or support another device to perform: (I) a process of a processor allowing a minter to mint fan tokens as much as a preset total upper limit of issuing the fan tokens, allowing the minter to issue the fan tokens to a vault as much as an initial issued number among the fan tokens of the preset total upper limit, and allowing a creator to distribute the fan tokens deposited in the vault, thereby registering information on the initial issued number of the fan tokens and thus updating information on a current total issued amount of the fan tokens; and
(II) the processor acquiring price information of the fan tokens exchanged in a liquidity pool, allowing the minter to additionally issue the fan tokens to the vault as much as a specific multiple of a preset unit number corresponding to a first price fluctuation condition whenever a reference price calculated by referring to the price information of the fan tokens during a preset criterion time is detected to satisfy the first price fluctuation condition, and registering information on the specific multiple of the preset unit number of the fan tokens additionally issued, thereby updating the information on the current total issued amount of the fan tokens.

18. The blockchain system of claim 17, wherein, at the process of (II), the processor calculates a time-weighted average price by referring to the price information of the fan tokens as the reference price during the preset criterion time, and checks whether the time-weighted average price exceeds a high-watermark which is a last highest price and whether the time-weighted average price has increased as much as a certain multiple of a preset unit price or has increased more than the certain multiple of the preset unit price from a specific criterion price among a plurality of preset criterion prices, to thereby check whether the reference price satisfies the first price fluctuation condition.

19. The blockchain system of claim 18, wherein, at the process of (II), the processor calculates the time-weighted average price during the preset criterion time for each period of time by referring to the price information of the fan tokens, and in case it is detected that the time-weighted average price exceeds the high-watermark and that the time-weighted average price has increased as much as the certain multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the time-weighted average price.

20. The blockchain system of claim 19, wherein, at the process of (II), the processor acquires the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool.

21. The blockchain system of claim 18, wherein, at the process of (II), the processor calculates time-weighted average prices during the preset criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the certain multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the specific time-weighted average price.

22. The blockchain system of claim 18, wherein, at the process of (II), processor is prevented from calculating the time-weighted average price during the preset criterion time of an initial stage.

23. A blockchain system for issuing one or more fan tokens based on a blockchain network, comprising at least one blockchain node comprising:
at least one memory that stores instructions; and
at least one processor configured to execute the instructions to perform or support another device to perform: (I) on condition that a total upper limit of issuing fan tokens has been set, a blockchain system allowing a minter to mint the fan tokens as much as a preset initial minted number, allowing the minter to issue the fan tokens to a vault as much as the preset initial minted number, and allowing a creator to distribute the fan tokens deposited in the vault, thereby registering information on the initial minted number of the fan tokens and thus updating information on a current total issued amount of the fan tokens; and
(b) the blockchain system acquiring price information of the fan tokens exchanged in a liquidity pool, calculating a reference price by referring to the price information of the fan tokens during a preset criterion time, allowing the minter to additionally mint the fan tokens as much as a specific multiple of a preset unit number corresponding to a second price fluctuation condition and then to issue the minted fan tokens to the vault whenever the reference price is detected to satisfy the second price fluctuation condition, and registering information on the specific multiple of the preset unit number of the fan tokens additionally minted, thereby updating the information on the current total issued amount of the fan tokens.

24. The blockchain system of claim 23, wherein, at the process of (II), the processor calculates a time-weighted average price by referring to the price information of the fan tokens as the reference price during the preset criterion time, and checks whether the time-weighted average price exceeds a high-watermark which is a last highest price and whether the time-weighted average price has increased as much as a certain multiple of a preset unit price or has increased more than the certain multiple of the preset unit price from a specific criterion price among a plurality of preset criterion prices, to thereby check whether the reference price satisfies the second price fluctuation condition.

25. The blockchain system of claim 24, wherein, at the process of (II), the processor calculates the time-weighted average price during the preset criterion time for each period of time by referring to the price information of the fan tokens, and in case it is detected that the time-weighted average price exceeds the high-watermark and that the time-weighted average price has increased as much as the certain multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the time-weighted average price.

26. The blockchain system of claim 24, wherein, at the process of (II), the blockchain system calculates time-weighted average prices during the preset criterion time for each period of time included in each of grouping cycle for additional issuance by referring to the price information of the fan tokens, and in case it is detected that there is a specific time-weighted average price, among the time-weighted average prices, which exceeds the high-watermark and which has increased as much as the certain multiple of the preset unit price or has increased more than the certain multiple of the preset unit price from the specific criterion price corresponding to the information on the current total issued amount, the blockchain system further issues the fan tokens to the vault as much as the specific multiple of the preset unit number which is set as corresponding to an increased cardinal number of the preset unit price of the specific time-weighted average price.

27. The blockchain system of claim 23, wherein, at the process of (II), the processor allows the creator to transmit the fan tokens to the minter as much as a particular multiple of the preset unit number corresponding to a third price fluctuation condition whenever the reference price is detected to satisfy the third price fluctuation condition, and allows the minter to burn the particular multiple of the preset unit number of the fan tokens transmitted from the creator, and registers information on the particular multiple of the preset unit number of the fan tokens burnt, thereby updating information on the current total issued amount of the fan tokens.

28. The blockchain system of claim 27, wherein, at the process of (II), the processor calculates a time-weighted average price by referring to the price information of the fan tokens as the reference price during the preset criterion time, and checks whether the time-weighted average price is maintained for at least a preset time after the time-weighted average price has decreased as much as a certain multiple of a preset unit price or has decreased more than the certain multiple of the preset unit price from a specific criterion price, to thereby check whether the reference price satisfies the third price fluctuation condition.

29. The blockchain system of claim 28, wherein, at the process of (II), the processor calculates the time-weighted average price during the preset criterion time for each period of time included in each of grouping cycle for additional issuance by referring to the price information of the fan tokens, and (i) in case the time-weighted average price (i-1) exceeds the high-watermark and (i-2) has increased as much as the certain multiple of the preset unit price or has increased more than the certain multiple of the preset unit price from the specific criterion price corresponding to the information on the current total issued amount, the blockchain system allows the minter to additionally mint the fan tokens as much as a first specific multiple of the preset unit number which is set as corresponding to an increased cardinal number of the preset unit price of the time-weighted average price and then to issue the minted fan tokens to the vault, and (ii) in case the time-weighted average price is maintained for at least a preset time after the time-weighted average price has decreased as much as the certain multiple of the preset unit price or has decreased more than the certain multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average price, and allows the minter to burn the second specific multiple of the preset unit number of the fan tokens transmitted from the creator.

30. The blockchain system of claim 29, wherein, at the process of (II), the processor acquires the specific criterion price by a mathematical formula as follow: (the specific criterion price)=(an initial criterion price)+(the current total issued amount−the initial issued number)/(the preset unit number)*(the preset unit price), wherein the initial criterion price is determined as an earliest criterion price of the fan tokens in the liquidity pool.

31. The blockchain system of claim 28, wherein, at the process of (II), the processor calculates time-weighted average prices during the preset criterion time for each period of time included in each of grouping cycle for additional issuance by referring to the price information of the fan tokens, and in case (i) it is detected that there is a specific time-weighted average price which exceeds the high-watermark and which has increased as much as the certain multiple of the preset unit price or has increased more than the certain multiple of the preset unit price from the specific criterion price corresponding to the information on the current total issued amount, the blockchain system allows the minter to further mint the fan tokens as much as a first specific multiple of the preset unit number which is set as corresponding to an increased cardinal number of the preset unit price of the specific time-weighted average price, and then to issue the minted fan tokens to the vault, and (ii) in case the time-weighted average prices are maintained for at least a preset time after the time-weighted average prices have decreased as much as the certain multiple of the preset unit price or have decreased more than the certain multiple of the preset unit price from the specific criterion price, the blockchain system allows the creator to transmit the fan tokens to the minter as much as a second specific multiple of the preset unit number which is set as corresponding to a decreased cardinal number of the preset unit price of the time-weighted average prices, and allows the minter to burn the second specific multiple of the preset unit number of the fan tokens transmitted from the creator.

32. The blockchain system of claim 28, wherein, at the process of (II), processor is prevented from calculating the time-weighted average price during the preset criterion time of an initial stage.
